(19) United States
(12) Patent Application Publication
(10) Pub. No.: US 2005/0181743 A1
(43) Pub. Date: Aug. 18, 2005

(54) Infant Safety Separation Monitor

(75) Inventor: Ronald R. Lawson, Cypress, TX (US)

Correspondence Address: Ronald R Lawson, 14919 Windmill Cove, Cypress Texas 77429, Cypress, TX, 77429, US

(73) Assignee: Ronald R Lawson, Cypress, TX (US)

(21) Appl. No.: 10/708,190

(22) Filed: Feb. 13, 2004

(51) Int. Cl. H04M 1/00; H04B 1/38

(52) U.S. Cl. 455/90.3; 455/90.2

(57) ABSTRACT

An infant safety monitoring device that monitors a transmitters coded radio frequency (RF) signal mounted on an infants vehicle safety seat to a matched RF decoding receiver; that a vehicle driver would carry. This RF transmission and receiving system can operate between 902 and 928 MHz with 916 MHz being the norm, and will sound an audible alarm when the a driver has exceeded an approximate safe distance of 40 feet from their child. The system uses paired hardwired ID addressing to allow for low interfere and providing security with the coded narrow band signal. The coupled units provide monitoring and warning of excessive separation distances between a driver with the receiver and their child in their infant safety seat. The system will help prevent a child from being inadvertently left in a vehicle unattended while the driver strays away.

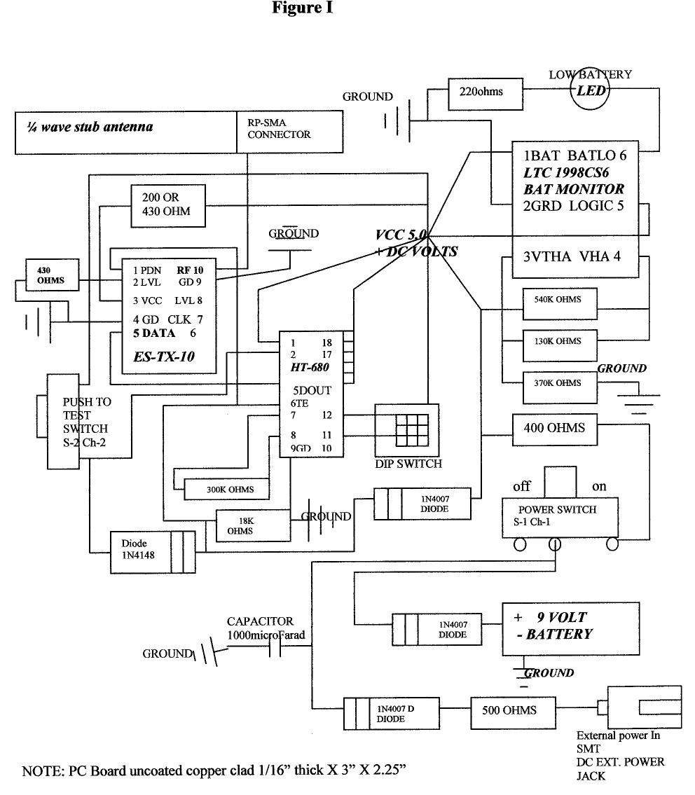

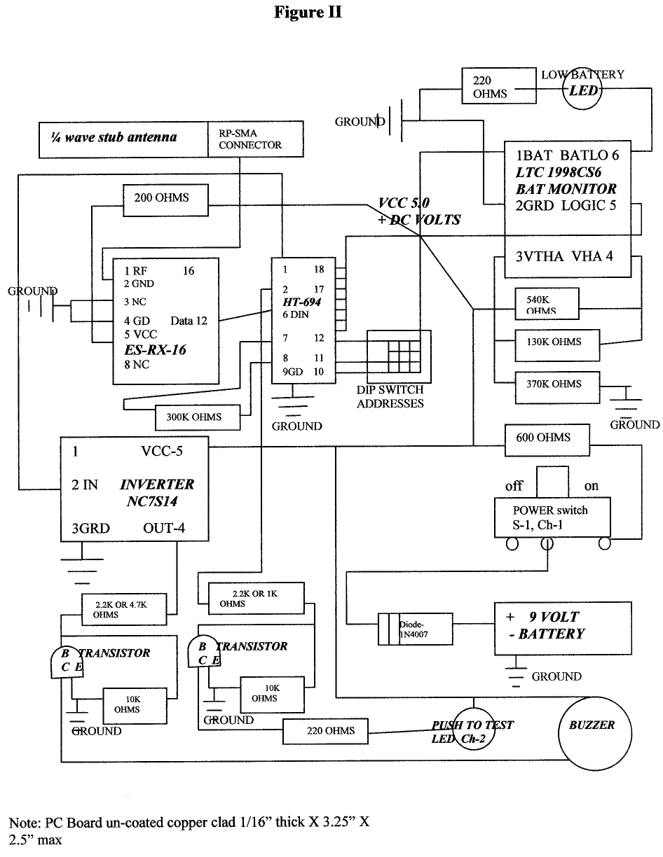

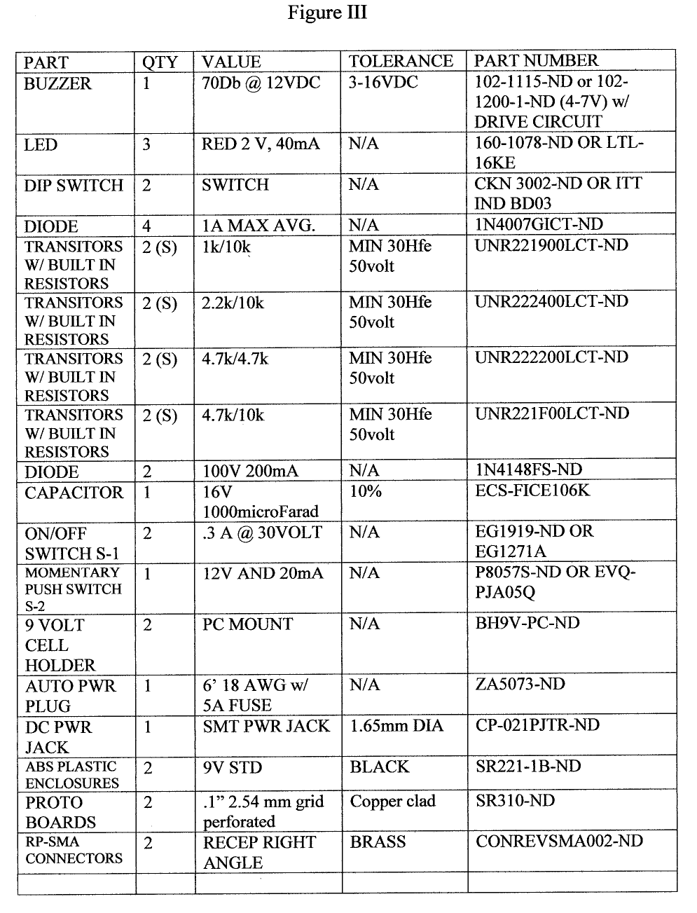

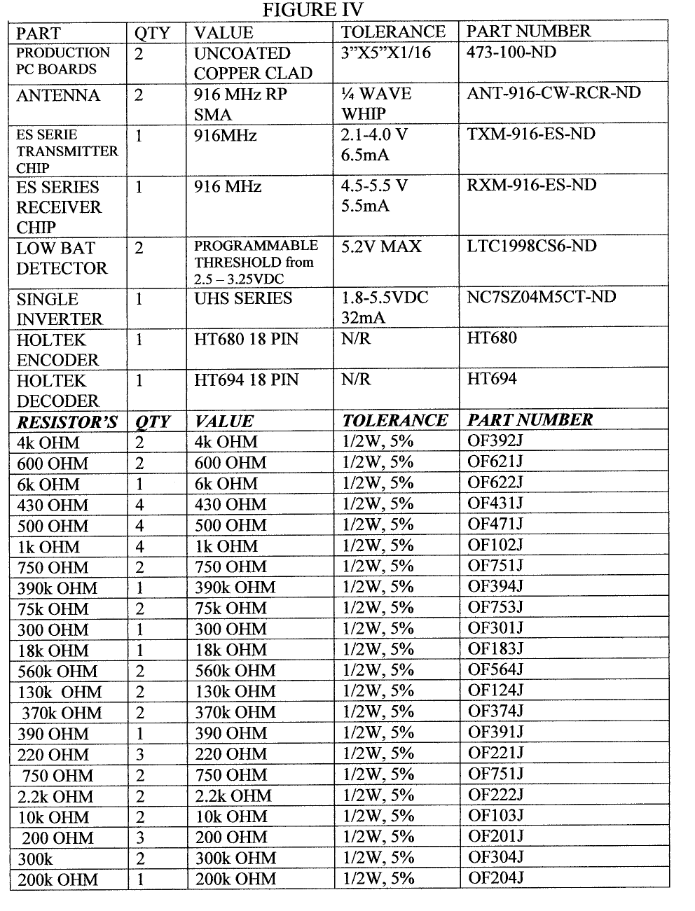

### SUMMARY OF INVENTION

The infant safety separation monitor is a radio frequency (RF) system that warns a driver of a vehicle carrying an infant in a vehicle safety seat that they have left their infant unattended in the vehicle. The system uses a RF transmitter attached to the infant safety seat and a matching RF receiver with alarm that the driver carries.

The transmitter transmits an omni-directional RF signal outward from the infant safety seat to a distance of approximately 40 feet. When the receiver, which is in the possession of the driver of the vehicle exceeds the propagation range of the transmitter; an alarm sounds.

The object of this invention is to prevent an infant from being inadvertently left in a vehicle unattended while the driver strays too far from the infant in their safety seat. This system is intended to be used as an infant safety alert system using RF energy range monitoring technology.

### DETAILED DESCRIPTION

The central component of each module is the use of a LINX TECHNOLOGIES ES Series digital RF transmitter and receiver chips. The transmitter and receiver are connected to Holtek encoder's and decoder's that are in parallel with a hardwired three throw DIP switch. The DIP switch set's the addresses for the coding and decoding. The coded signal minimizes RF interference and provides security from unauthorized monitoring of the transmitter's signal. The operating frequency of the systems will be between 902 and 928 MHz (megahertz), where FCC regulations are the least restrictive. Both units are encased in nonflammable ABS plastic enclosures with all the applicable switches, LED's, buzzer's, batteries, power jack, electrical components (chips, transistors, resistors, and capacitors) and with an antenna's mounted onto the 1/16 inch thick uncoated copper clad PC boards.

The receiver has an additional Linear Technology inverter chip set to change logic states of the processed signal. When the signal is received from the transmitter a high state is created following decoding, this signal must be inverted so that the alarm is not activated during the high state. Therefore, the high state is inverted to a low state (or off condition). When no signal is received, a low state is created out of the decoded, but at this point the warning alarm should sound. Therefore, the low signal from the decoder must be inverted to a High (on) state to activate the switching transistor to drive the alarm buzzer.

The pairing of the transmitter and receiver unit forms the wireless RF link that transmits and receives uniquely coded signals that allows for alarm activation when the maximum transmitted range of 40 feet is exceeded. A second receiver unit can be configured to use with the one transmitter to allow for multiple drivers. The receiver is designed to be used as a key chain or to attach to a key chain and has a single on/off switch. The transmitter is to be permanently mounted to the infant car seat. It is turned on to transmit at all times when the infant is seated. An external power plug is optional.

The system is designed to operate with replaceable batteries to provide at least 5.0VDC for the internal circuitry. This 5.0 VDC is known as VCC for this description. The internal circuits are designed to operate from 3.0 to 5.2 VDC. A low battery warning light circuit is built into both transmitter and receiver units and will activate at 2.9 volts to alert the user of a low voltage. The Linear Technology LTC 1998 chip will monitor VCC voltage that is connected to pin 1 of the LTC chip. The chip will be programmed to have a hysteresis of 0.25 volts that is set by parallel resistors between pin 3 and 4 of 130 k ohms and a 370 k ohm resistor from pin 3 to ground. This provides for 1.5VDC to pin 3. A 540 k resistor from VCC to pin 4 also programs the hysteresis. Pin 5 connects directly to VCC, which will provide VCC to pin 6 during the low battery LED activation and which is in series with a 220 ohm resistor to ground.

The transmitter can be fitted with an optional vehicle cigarette lighter power cord (Digikey p/n: ZA5073-ND) that plugs into the power jack of the transmitter. These circuits will have a voltage dividing resistor of 500 ohms and a diode prior to input providing 9.0 VDC to the S-1 (Channel 1) power switch. A capacitor of 1000 microFarad smooths out any voltage spikes from the vehicle power plug. Following the power switch both units will have 400 to 600 ohm resistors to drop to VCC voltage of 5.0VDC. The VCC input to both LINX units chips can have resistors between 200 to 430 ohms to further drop the voltage between 3.5 to 4.8 VDC to regulate the power output and receiving power sensitivity.

The ES-TX-10 transmitter chip transmits data using amplitude modulation (AM) when a high (“1”) or when the circuit is turned on. In this configuration the “Infant safety separation monitor” will have the on/off switch (S1-Ch1) providing continuous power to the chip set. With the power switch on a signal is generated on channel 1, generating a continuous digitized 3 worded transmission cycle until the unit is turned off. The push to test button on the transmitter is known as channel 2. When momentarily pushed down an “on or high” signal activates the ES-TX-10 chip to transmit a 3-worded coded signal to the receiver on channel 2. When the receiver receives this signal on channel 2 an LED momentarily lights which provides a circuit test.

A 200 to 430 ohm resistor prior to pin 3 of the ES-TX-10 transmitter chip provides a voltage of at least 3.8 to 4.8 VDC. Power to the Holtek HT-680 encoder chip is provided to pin 1 from VCC, grounding is provided on pins 3,4 and 9. The encoding of the transmitter signal is provided by the encoder paralleled to a hardwired three-throw DIP switch that sets the coded ID address states. These DIP switches can be configured in various on/off configurations providing the unique and secure addressing. The DIP switch used to set ID code can be configured for 256 unique transmitter/receiver pairings. The receiver must have the exact same DIP switch configuration in order to receive and translate the RF signal. They also reduce susceptibility to RF interference. The DIP switch is connected to pins 10,11 and pin 12 of the encoder chip and powered by VCC. Pin 6 is grounded through a 18 k ohm resistor. A 390 k resistor connects pin 7 and 8 of the encoder (OSC1 and 2), ground is provided to pin 9. The push to test switch which is powered by VCC is connected to pin 2 and also routed through a diode and 18 k ohm resistor to pin 6 of the encoder and ground. From pin 6 of the encoder it also routes to pin 1 of the transmitter chip.

The output of the encoder chip is provided at DOUT pin 5 and directly connects to pin 5 (Data in) of the ES-TX-10 transmitter chip. The narrow bandwidth output RF signal of the transmitter chip is from pin 10, which connects directly to a RP-SMA antenna connector. The signal exits to a modified ¼ wavelength whip antenna. A special resistor can be placed in series between pin 10 of the transmitter chip to RP-SMA connector to attenuate the output power. The attenuated power is to provide the 40 feet transmission distance. The receiver must be in this 40 feet transmission range to receive the digitally coded RF transmission. If the receiver does not receive the transmitted signal the receiver alarm circuit activates notifying the receiver that they have exceeded the 40 feet transmission range.

The digital receiver will receive the uniquely coded transmitted signals from either channel 1 or channel 2 of the transmitter. The transmitted signal is picked up by a modified ¼ wavelength whip antenna connected to SP-SMA connector and routed through an optional attenuating resistor directly to pin 1 of the ES-RX-16 receiver chip. Receiver chip is powered from VCC that routes through a 200 to 430 ohm voltage dropping resistor to provide a voltage between 3.8 and 4.2VDC. The output from the receiver chip pin 12 is connected to the decoder (Holtek HT-694) chip pin 6 (Data-In). The decoder is configured to the same DIP switch configuration as the transmitter or the signal will not be translated or used. When the decoder determines that its paired transmitter signal has been received; a signal from either pin 1(Channel 1) or pin 2 (Channel 2) of the decoder chip will duplicate the transmitters activation mode (Channel select) by providing a an on state to either pin 1 or 2. The receivers decoder Pin 1 (Channel 1) will activate when the transmitters on/off (S-1, Channel1) switch is turned on and when the units are within the 40 feet transmission range. Channel 2 (or the transmitter's push to test circuit) will go to high on pin 2 of the encoder's chip when the push to test button is pressed on the transmitter unit which will power a push to test LED. The LED requires a switching integrated resistor transistor circuit to power the LED.

Pin 1 (Channel 1) from the decoder is connected to the Fairchild NC7S14 HS digital logic inverter input pin number 2 (In). The inverter is powered by VCC connected at pin number 5. The chip is connected to ground with pin number 3. The inverted output signal exits at pin 4 (out), which is routed to an integrated resistor transistor drive buffer to power the 3-16VDC (70 dB) buzzer. As discussed earlier the inverter is required to allow the alarm to activate when a low state (no signal) to the receiver is received.

To begin operating the units; mount the transmitter onto the infant car seat with the two 8-32×0.75″ protruding bolts. Attach the receiver to a key chain or use it as a key chain. The system is easy to use by just turning on both units with their on/off switches. Test functionality by separating the two units by a distance greater than 40 feet. At this point the alarm should come on. To turn off the alarm place the two units within the 40 feet transmission radius; the alarm should stop. If the alarm does not sound, check that the low battery LED is not “on” to ensure the batteries are good. Pressing the push to test button on the transmitter can test the RF link with the push to test LED lighting on the receiver unit. If the LED does not illuminate replace the batteries and retry. An external cigarette lighter adapter plugged into the transmitters power jack can also power the transmitter. This completes assembly and useage of the infant safety separation monitor.

1. What I claim as my invention is an infant safety-monitoring system using radio frequency that monitors and warns of an excessive range between a transmitter and matched receiver.

2. A method wherein the system warns a driver of a vehicle that they have exceeded a safe distance from their infant in their infant vehicle safety seat.

3. A method wherein the goal is to prevent an infant from being inadvertently left unattended in a vehicle safety seat.

4. A method wherein the RF transmitter is permanently attached to the infants vehicle safety seat.

5. A method wherein the warning alarm on the receiver sounds when outside an approximate 40 feet transmission range of the transmitter.

6. A method wherein the digital transmitter and receiver units are paired by using encoder and decoder chips with selective ID address codes.

7. A method wherein both units are powered by replaceable batteries providing a minimum of 3.0 VDC to the internal circuitry.

8. A method wherein the battery power are monitored with a low battery LED warning.

9. A method wherein the RF receiver is held by a driver of vehicle in a small key chain size packaging.

10. What I claim as my invention is a transmitter that is capable of transmitting two channels of digitally coded information from 902 to 928 megahertz (MHz).

11. A method wherein the RF signal is encoded with an encoder chip hardwired to a DIP switch to set address codes.

12. A method wherein the transmitters on/off switch provides a data signal on channel 1.

13. A method wherein the transmitters push to test button transmits data to receiver on channel 2.

14. A method wherein the transmitter is encased in a fire retardant ABS plastic case.

15. A method wherein the transmitter will be encased in a case no larger than 3.0 inches by 2.25 inches by 1.25 inches.

16. What I claim as my invention is a digital radio frequency receiver that is capable of receiving digitally coded data signals from a paired transmitter operating between 902 and 928 MHz.

17. A method wherein the RF signal is decoded with a decoder chip hardwired to a DIP switch to set address codes.

18. A method wherein the transmitters on/off switch provides a data signal on channel 1 of the receiver's audible alarm circuit.

19. A method wherein the transmitters push to test button transmits data to the receiver's channel 2 push to test LED circuitry.

20. A method wherein the receiver is encased in a fire retardant ABS plastic case.

21. A method wherein the receiver will be encased in a case no larger than 3.25 inches by 2.5 inches by 1.25 inches.
